(19) United States
(12) Patent Application Publication
(10) Pub. No.: US 2014/0300061 A1
(43) Pub. Date: Oct. 9, 2014

(54) Bullet Nose Grommet for Radiator Assembly

(71) Applicant: Caterpillar Inc., Peoria, IL (US)

(72) Inventors: Sudhakara Reddy Gopireddy, Dunlap, IL (US); Mahesh Kumar Mokire, Dunlap, IL (US); Neil Alan Terry, Edelstein, IL (US); Sumeeth Sivanagere, Dunlap, IL (US); Khaled M. Mohammad, Tremont, IL (US); Daniel Melvin Keehner, Peoria, IL (US)

(21) Appl. No.: 13/859,298

(22) Filed: Apr. 9, 2013

(51) Int. Cl. F16L 21/00; F28F 9/06

(52) U.S. Cl. CPC F16L 21/002; F28F 9/06
USPC 277/607

(57) ABSTRACT

A grommet for insertion into an opening of a radiator header plate may have a cylindrical outer surface having a body outer diameter, an annular shoulder proximate a top surface and extending outwardly beyond the outer surface of the body, and an annular bead proximate a bottom surface of the body and extending outwardly beyond the outer surface of the body and have a bead outer diameter that is greater than the body outer diameter. The annular bead may include a tapered bottom portion having a decreasing outer diameter as the tapered bottom portion extends downwardly toward the bottom surface of the body, with the tapered bottom portion terminating with a bottom outer diameter that is less than the body outer diameter.

### TECHNICAL FIELD

This disclosure relates generally to tube-and-fin style heat exchangers. More particularly, this disclosure relates to a bullet nose grommet for facilitating assembly of a radiator formed by a plurality of tube-and-fin assemblies mounted between coolant manifolds.

### BACKGROUND

Large heavy duty machines, such as dozers, loaders and excavators, require large radiators for engine cooling. One common radiator design is the tube-and-fin structure, where numerous tube-and-fin assemblies are mounted to upper and lower coolant manifolds and arranged in columns and rows. Copper grommetted tube (CGT) radiators, in which copper tube-and-fin assemblies are secured to coolant manifolds or other radiator components, are expensive. The pursuit of cost reduction in manufacturing the machines has led to the development of aluminum grommetted tube (AGT) radiators. Aluminum is less expensive and lighter than copper than copper, but is less malleable.

The tube-and-fin assemblies that make up a CGT or AGT radiator are secured to the coolant manifolds and sealed thereto with flexible grommets or seals. Each of the tubes may comprise an annular bead extending outwardly around a lower end of the tube, and each of the seals includes a circumferential groove for receiving the bead and holding the tube-and-fin assembly in place. One such tube and seal construction radiator disclosed in U.S. Pat. No. 3,391,732 issued to Murray on Jul. 29, 1966, includes upper and lower radiator tank members having holes in the lower and upper surfaces, respectively, with removable lengths of finned conduit extending there between and resilient grommets positioned in the holes so as to surround the conduits adjacent the ends thereof to prevent leakage there around. A radially outwardly extending flange is formed adjacent the lower end of each of the conduits and the lower grommets have grooves in the inner surfaces thereof. The grooves receive the flanges on the conduits and substantially prevent inadvertent disengagement of the conduits from the holes. Additional combinations of radiator constructions having conduits with conduit ends engaged by grommets or seals to retain the conduit ends within openings of a header plate are disclosed in U.S. Pat. No. 5,433,268 issued to Janezich et al. on Jul. 18, 1995.

In tube and grommet combinations such as those taught in the references cited above, the body of the grommet is typically fabricated from rubber or other resilient material, and has an outer diameter that is greater than the inner diameter of the opening through the header plate so that the grommet fits tightly within the opening when the grommet is inserted therein. This dimensional relationship assists in ensuring a tight seal between the grommet and the header plate, but can cause issues during assembly of the radiators. The bottom edge of the grommet is larger than the opening in which the grommet will be installed, and an interference relationship exists when the grommet is lined up with the opening. When a force is applied to press the grommet into the opening, the force must compress the grommet until the force overcomes the interference between the bottom edge of the grommet and the outer surface of the header plate. The required force is further increased when the grommet is misaligned with the header plate opening, and the grommet may even fall over or partially fall into the opening and require repositioning before the grommet can be installed in the opening. In conventional CGT and AGT radiators, hundreds of tubes are installed between the headers, and each tube requires a grommet for each header. Consequently, a radiator having 760 tubes will require 1520 grommets that must each be installed in a corresponding opening. With the high number of components to be assembled, the manufacturing time can be increased substantially where systematic problems exist in installing the previously known grommets in the header plates. In view of this, a need exists for an improved grommet design for radiator assemblies providing more reliable positioning of the grommets with respect to the header plate openings in which they will be inserted to reduce the manufacturing time required for the radiator assembly, and reducing the force necessary to install the grommets within the header plate openings.

### SUMMARY OF THE DISCLOSURE

In one aspect of the present disclosure, a grommet for insertion into an opening of a header plate of a radiator is disclosed. The grommet may include a generally cylindrical body having a top surface, a bottom surface, and a cylindrical outer surface having a body outer diameter, an annular shoulder proximate the top surface of the body and extending outwardly beyond the outer surface of the body and having a shoulder outer diameter that is greater than the body outer diameter, and an annular bead proximate the bottom surface of the body and extending outwardly beyond the outer surface of the body and having a bead outer diameter that is greater than the body outer diameter. The annular bead comprises a tapered bottom portion having a decreasing outer diameter as the tapered bottom portion extends downwardly toward the bottom surface of the body, with the tapered bottom portion terminating with a bottom outer diameter that is less than the body outer diameter.

In another aspect of the present disclosure, a grommet for insertion into an opening of a header plate of a radiator is disclosed. The grommet may include a generally cylindrical body having a top surface, a bottom surface, a cylindrical outer surface having a body outer diameter, and an inner surface defining a cylindrical bore extending from the top surface of the body to the bottom surface of the body. The grommet may also include an annular shoulder proximate the top surface of the body and extending outwardly beyond the outer surface of the body and having a shoulder outer diameter that is greater than the body outer diameter, and an annular bead proximate the bottom surface of the body and extending outwardly beyond the outer surface of the body and having a bead outer diameter that is greater than the body outer diameter. The annular bead may include a curved top portion and a tapered bottom portion having a decreasing outer diameter as the tapered bottom portion extends from the curved top portion downwardly toward the bottom surface of the body, with the tapered bottom portion terminating with a bottom outer diameter that is less than the body outer diameter. A cylindrical body bottom portion of the grommet may extend from the tapered bottom portion of the annular bead to the bottom surface of the body. The body bottom portion may have a bottom portion outer diameter equal to the bottom outer diameter of the tapered bottom portion.

Additional aspects are defined by the claims of this patent.

### BRIEF DESCRIPTION OF THE DRAWINGS

FIG. 1 is a perspective view of a tube-and-fin assembly for use in a radiator;

FIG. 2 is a partial perspective view of a portion of the tube-and-fin assembly of FIG. 1 shown with an embodiment of a grommet in accordance with the present disclosure and a portion of a header plate having an opening for receiving the grommet and a bottom end of a tube-and-fin assembly;

FIG. 3 is a side cross-sectional view of the grommet and header plate of FIG. 2 taken through line 3-3 of FIG. 2;

FIG. 4 is an enlarged view of Detail 4 of the grommet of FIG. 3;

FIG. 5 is a side cross-sectional view of the grommet and the header plate of FIG. 2 with the lower end of the grommet inserted at the top of the header plate opening;

FIG. 6 is a side cross-sectional view of the grommet and the header plate of FIG. 2 with the grommet inserted through the header plate opening; and

FIG. 7 is a side cross-sectional view of the installed grommet and header plate opening of FIG. 6 with a bottom end of the tube-and-fin assembly of FIG. 1 inserted into and retained by the grommet.

### DETAILED DESCRIPTION

Although the following text sets forth a detailed description of numerous different embodiments of the present disclosure, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112(f).

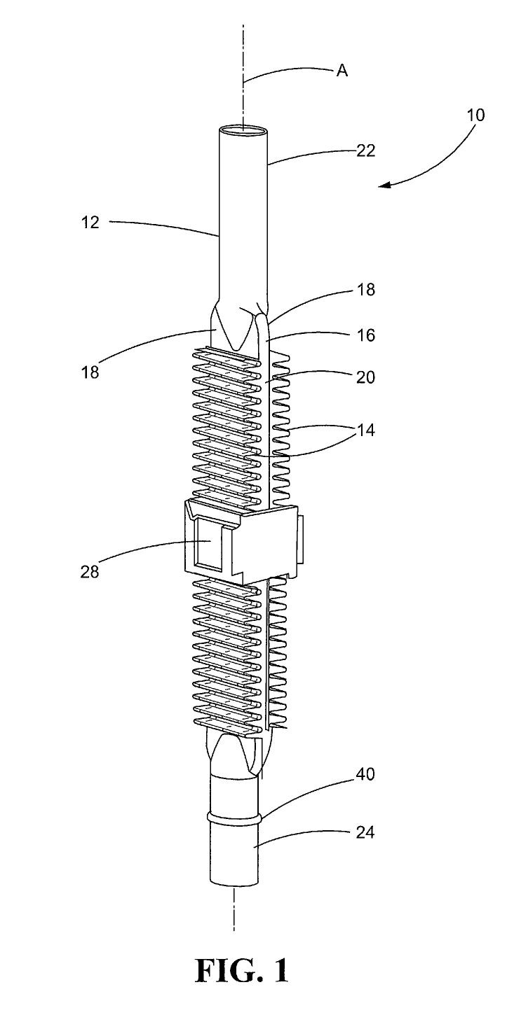

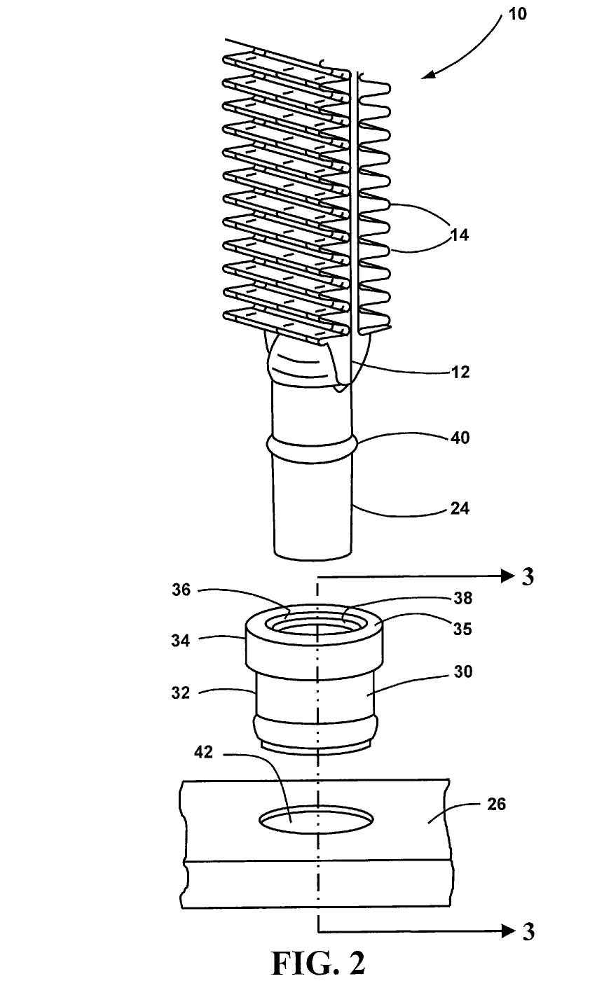

FIG. 1 is a perspective view of a tube-and-fin assembly 10 of the kind used in a radiator for a large heavy duty vehicle. The tube-and-fin assembly 10 comprises a tube 12 having a plurality of fins 14 extending outwardly there from. The tube 12 has an outer surface and a generally elliptical, cylindrical and elongated body 16 having flattened sides 18 connected by rounded ends 20 and defining a longitudinal axis A. The tube 12 may further include a generally cylindrical top end 22 and a generally cylindrical bottom end 24 for attachment to header plates 26 (FIG. 2) of coolant manifolds (not shown). Each fin 14 extends radially outward from a side 18 of the elongated body 16. As explained further below, the tube 12 is supported by a bullet nose seal or grommet 30 (FIG. 2) at least at the bottom end 24 to prevent leakage between the bottom end 24 and the header plate 26 of the corresponding coolant manifold.

FIG. 2 is a partial perspective view of the bottom portion of the tube-and-fin assembly 10 of FIG. 1 shown along with the corresponding bullet nose seal or grommet 30 and the header plate 26 of the corresponding coolant manifold. The grommet 30 may be fabricated from rubber or other suitable resilient material capable of deforming and engaging the header plate 26 to form a substantially air-tight and water-tight seal there between. The grommet 30 may also be provided with a coating material, such as a Teflon® coating, to increase the overall robustness of the grommet 30. The grommet 30 has a generally cylindrical body 32, an annular flange or shoulder 34 extending outwardly from the body 32 proximate a top surface 35 of the grommet 30, and an inner surface defining a longitudinal bore 36 through the body 32 of the grommet 30. The inner surface further defines an annular groove 38 within the bore 36 and extending into the annular shoulder 34 and configured to receive an annular bead 40 on the outer surface of the bottom end 24 of the tube 12. The bead 40 is formed circumferentially around the bottom end 24 of the tube 12. The bead 40 may be integrally formed as part of an extruded tube 12, and is designed to help secure the tube 12 to a coolant manifold by fitting within the annular groove 38 formed in the grommet 30 when the bottom end 24 of the tube 12 and the grommet 30 are installed within an opening 42 of the header plate 26.

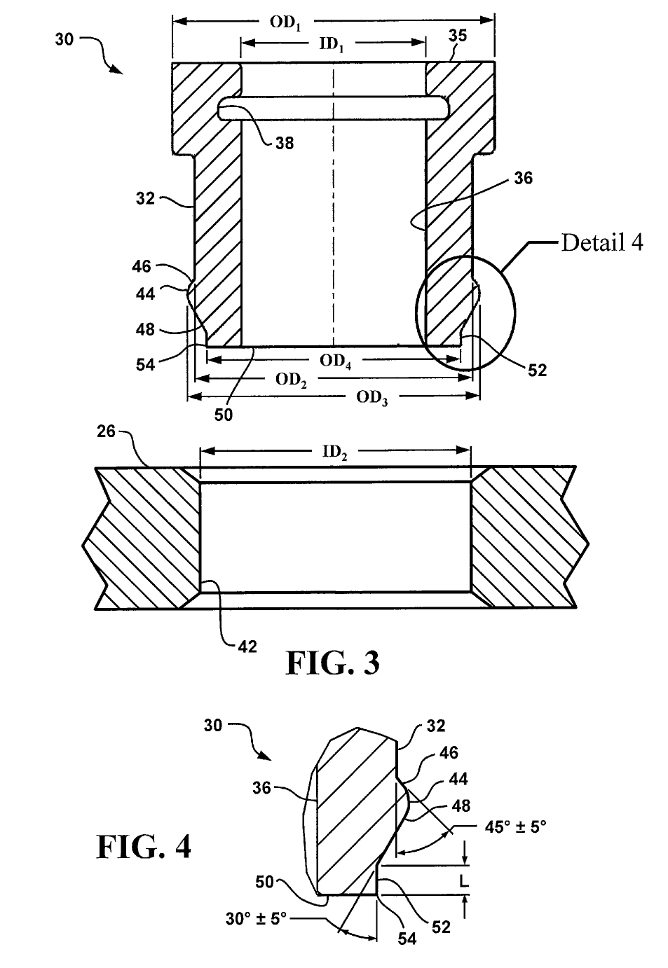

The grommet 30 and the opening 42 are dimensioned so that the grommet 30 may be press fit into the opening 42 of the header plate 26, and retained in the opening 42 after the being inserted there through. FIG. 3 provides a cross-sectional view of the grommet 30 prior to installation in the opening 42 of the header plate 26 of a coolant manifold. The longitudinal bore 36 of the grommet 30 has a bore inner diameter ID₁ that is large enough to receive the corresponding bottom end 24 of the tube 12 with the bead 40 of the bottom end 24 being received within and retained by the annular groove 38 as will be discussed further below. As discussed above, the annular shoulder 34 of the grommet 30 extends outwardly from the body 32 proximate the top surface 35. A shoulder outer diameter OD₁ is greater than a body outer diameter OD₂ of the body 32. The body outer diameter OD₂ may be greater than an opening inner diameter ID₂ of the opening 42 through the header plate 26 to provide a tight fit when the grommet 30 is installed within the opening 42.

At the opposite end of the body 32 from the annular shoulder 34, an annular detent or bead 44 extends outwardly from the body 32 to provide an additional structure for engaging the header plate 26 to retain the grommet 30 within the opening 42. The annular bead 44 extends outwardly to a maximum extent where the annular bead 44 has a bead outer diameter OD₃ that is greater than the body outer diameter OD₂. The annular bead 44 includes a rounded or curved top portion 46 that transitions to a tapered bottom portion 48. The curved top portion 46 may have radius of curvature and an outer surface having a substantially circular arc. However, the outer surface of the curved top portion 46 may have a non-circular arc with an alternative type of non-circular curvature, such as elliptical, ovoid and the like. The arc of the curved top portion 46 extends downwardly past the location of the maximum bead outer diameter OD₃ and turns back inwardly toward the bore 36 to a point at which the curved top portion 46 transitions to the tapered bottom portion 48. The tapered bottom portion 48 may have an outer surface having a frusto-conical shape that tapers from a maximum outer diameter at the point of transition from the curved top portion 46 to a minimum bottom outer diameter OD₄ as the tapered bottom portion 48 approaches a bottom surface 50 of the grommet 30.

In the illustrated embodiment, the tapered bottom portion 48 terminates at a cylindrical bottom portion 52 extending between the tapered bottom portion 48 and the bottom surface 50 of the grommet 30. As shown, the cylindrical bottom portion 52 has a constant outer diameter that is equal to the bottom outer diameter OD₄ of the tapered bottom portion 48. The bottom outer diameter OD₄ is smaller than the body outer diameter OD₂ and is also smaller than the opening inner diameter ID₂ of the header plate 26. Dimensioned in this way, the bottom portion 52 may be inserted into the opening 42 of the header plate 26 with minimal engagement with the inner surface defining the opening 42 to facilitate installation of the grommet 30 within the opening 42 as will be discussed further below. In alternative embodiments, the bottom portion 52 may taper inwardly as the bottom portion 52 extends toward the bottom surface 50 but at a shallower angle than the tapered bottom portion 48 of the annular bead 44, or the bottom portion 52 may taper outwardly and terminate at the bottom surface 50 with an outer diameter that is greater than the bottom outer diameter OD₄. In each alternative, however, the outer diameter at the bottom surface 50 may be smaller than the opening inner diameter ID₂, or at most be approximately equal to the opening inner diameter ID₂ so that minimal force is required to insert the bottom portion 52 of the grommet 30 into the opening 42.

The lower portion of the grommet 30 of the present embodiment is shown in greater detail in FIG. 4. The bottom portion 52 is cylindrical and extends downwardly from the tapered bottom portion 48 of the annular bead 44 by a length L and intersects the bottom surface 50 of the grommet 30 at a bottom edge 54. The curved top portion 46 of the annular bead 44 may extend from the body 32 of the grommet 30 at an initial angle with respect to a line parallel to the outer surface of the body 32 with a value within a range having a lower limit of approximately 40° and an upper limit of approximately 50°, and in some embodiments having a value of approximately 45°. The tapered bottom portion 48, after transitioning from the curved top portion 46, may approach the bottom surface 50 at an angle with respect to a line parallel to the outer surfaces of the body 32 and/or the cylindrical bottom portion 52 with a value within a range having a lower limit of approximately 25° and an upper limit of approximately 35°, and in some embodiments having a value of approximately 30°. Those skilled in the art will understand that the angles of the curved top portion 46 and the tapered bottom portion 48 of the annular bead 44 are used for the purpose of illustrating the present embodiment. Portions 46, 48 having angles falling outside the ranges illustrated and discussed therein may be implemented in the grommets 30 disclosed herein, and are contemplated by the inventors as having use in bullet nose grommets 30 in accordance with the present disclosure.

### INDUSTRIAL APPLICABILITY

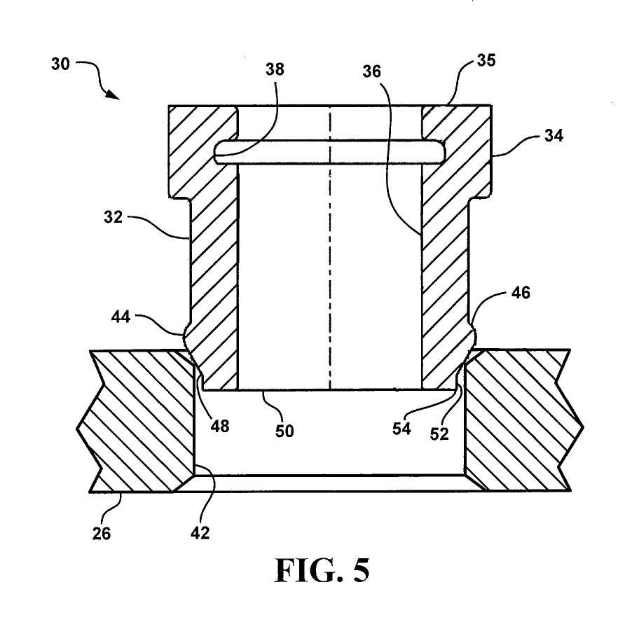

The process for installing the tube-and-fin assemblies 10 and the grommets 30 in the header plates 26 of the coolant manifolds of the radiator may be performed manually or may be automated, but either assembly process may be improved by the configuration of the bullet nose grommets 30 in accordance with the present disclosure. FIG. 5 illustrates the grommet 30 after an initial step in the process of inserting the grommet 30 into the corresponding opening 42 of the header plate 26. The cylindrical bottom portion 52 of the grommet 30 is inserted within the opening 42. Because the bottom outer diameter OD₄ of the bottom portion 52 is less than the opening inner diameter ID₂, the bottom portion 52 fits easily into the opening 42. The smaller bottom outer diameter OD₄ also requires less precision in the placement of the grommet 30 within the opening 42. The grommet 30 may be slightly misaligned with the opening 42 and the cylindrical bottom portion 52 can still pass into the opening 42. In contrast, previous grommets with the bottom surface having an outer diameter greater than the opening inner diameter ID₂ required more precision in alignment of the grommet so that the grommet could be press fit into the opening 42 without unduly increasing the force necessary to press the grommet into the opening 42.

The bottom portion 52 is inserted into the opening 42 until the tapered bottom portion 48 of the annular bead 44 engages an upper edge of the opening 42 as shown in FIG. 5. Engagement between the upper edge of the opening 42 and the tapered bottom portion 48 of the annular bead 44 provide self-alignment of the grommet 30 in a generally vertical orientation as shown. In previously-known grommets sitting on the top surface of the header plate 26 prior to full insertion, it is possible for the grommets to topple over if the header plate shifts or if the grommets are contacted by an installer or installation equipment. In the present design, the grommets 30 more reliably remain upright and in position for installation even when disturbed by external forces. If the grommet 30 begins to tip over, the bottom edge 54 can engage the inner surface of the opening 42 to resist further movement of the grommet 30 and prevent the grommet 30 from falling out of the opening 42.

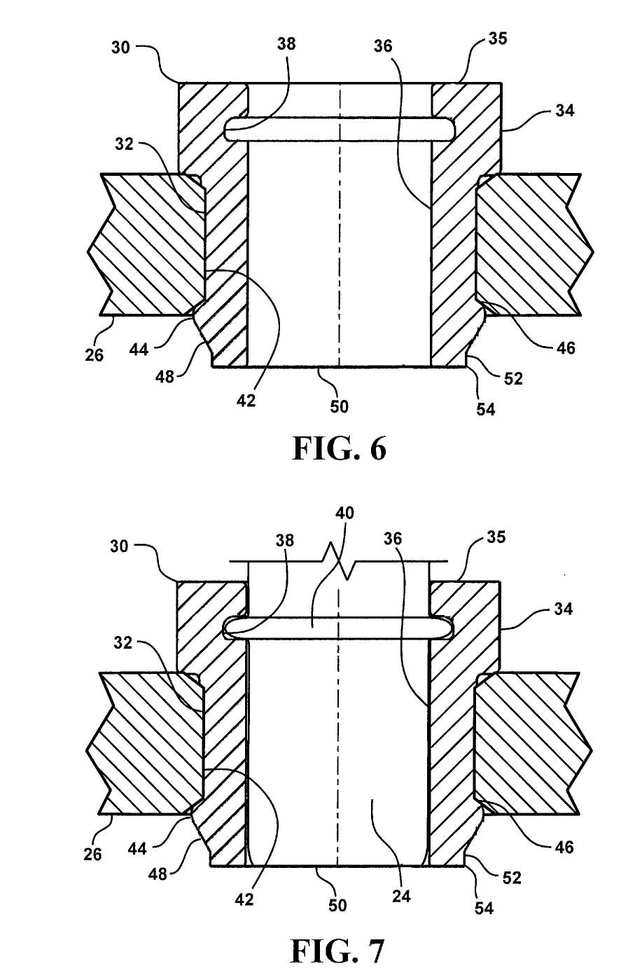

Once the grommet 30 is in the position shown in FIG. 5, the grommet 30 is prepared for application of a downward force to press the grommet 30 downward and through the opening 42. When the force is applied at the top surface 35 of the grommet 30, the grommet 30 is pressed downward and the resilience of the material from which the grommet 30 is formed allows the annular bead 44 to compress inwardly as the wider section of the tapered bottom portion 48 is pushed past the upper edge of the opening 42. The annular bead 44 and the body 32 of the grommet 30 slide through the opening 42 of the header plate 26 until the curved top portion 46 of the annular bead 44 clears a lower edge of the opening 42 as shown in FIG. 6. Without the inward force applied by the inner surface of the opening 42, the annular bead 44 expands toward its normal shape and the curved top portion 46 of the annular bead 44 engages the bottom edge of the opening 42 to retain the body 32 of the grommet 30 within the opening 42 against the normal operating pressures that will occur within the coolant manifold. At the same time, the annular shoulder 34 may engage the upper surface of the header plate 26 to provide a secondary seal on the outside of the header plate 26. When the body outer diameter OD₂ is greater than the opening inner diameter ID₂, a substantially air-tight and water-tight primary seal is formed between the outer surface of the body 32 and the inner surface of the opening 42 to prevent pressurized liquid or vapor from leaking out of the coolant manifold around the grommet 30.

After the grommet 30 is installed within the opening 42, the bottom end 24 of the tube 12 is inserted into the bore 36 of the grommet 30 to complete the installation of the tube-and-fin assembly 10 in the opening 42 of the header plate 26. The bottom end 24 of the tube 12 is inserted into the bore 36 of the grommet 30 at the top surface 35. The outer diameter of the bottom end 24 may be greater than the bore inner diameter ID₁ so that a seal may be formed between the outer surface of the bottom end 24 of the tube 12 and the inner surface of the bore 36. As the bottom end 24 slides downward into the bore 36, the bead 40 of the bottom end 24 comes into contact with the top surface 35 of the grommet 30. As the bottom end 24 is pressed further down into the bore 36, the bead 40 causes the portion of the bore 36 at the annular shoulder 34 to deflect outwardly to allow the bead 40 to enter the bore 36. Eventually, the bead 40 is received into the annular groove 38 of the grommet 30 and the portion of the bore 36 above the annular groove 38 collapses around the corresponding portion of the bottom end 24 to engage the bead 40 and retain the bottom end 24 of the tube 12 within the bore 36 as shown in FIG. 7.

The bullet nose grommet 30 as illustrated and described herein provides more reliable positioning of the grommet 30 within the opening 42 of the header plate 26 during assembly of the tube 12 and header plate 26. Proper alignment of the grommet 30 provided by the tapered bottom portion 48 of the annular bead 44 and the cylindrical bottom portion 52 of the body 32 allows the grommet 30 to be press fit into the opening 42 of the header plate 26 without requiring the additional force that is necessary to press a misaligned grommet into the opening 42. The grommet 30 is less likely to become dislodged or fall over, thereby reducing the additional assembly time and effort required with previously-known grommets to reposition the grommets after falling over. Ease of installation of the tube-and-fin assemblies 10 provided by the bullet nose grommet 30 can result in a significant savings in assembly time and cost for CGT, AGT and other types of radiators where hundreds or thousands of tube-and-fin assembly 10 and grommet 30 combinations must be installed in a single radiator.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

What is claimed is:

1. A grommet for insertion into an opening of a header plate of a radiator, the grommet comprising:
a generally cylindrical body having a top surface, a bottom surface, and a cylindrical outer surface having a body outer diameter;
an annular shoulder proximate the top surface of the body and extending outwardly beyond the outer surface of the body and having a shoulder outer diameter that is greater than the body outer diameter; and
an annular bead proximate the bottom surface of the body and extending outwardly beyond the outer surface of the body and having a bead outer diameter that is greater than the body outer diameter, wherein the annular bead comprises a tapered bottom portion having a decreasing outer diameter as the tapered bottom portion extends downwardly toward the bottom surface of the body, with the tapered bottom portion terminating with a bottom outer diameter that is less than the body outer diameter.

2. The grommet of claim 1, wherein the annular bead comprises a curved top portion that transitions to the tapered bottom portion.

3. The grommet of claim 2, wherein the curved top portion comprises an outer surface having a circular arc.

4. The grommet of claim 2, wherein the curved top portion of the annular bead extends outwardly from the outer surface of the body at an initial angle with respect to a line parallel to the outer surface of the body having a value within a range having a lower limit of approximately 40° and an upper limit of approximately 50°.

5. The grommet of claim 4, wherein the initial angle of the curved top portion is equal to approximately 45°.

6. The grommet of claim 1, wherein the tapered bottom portion of the annular bead approaches the bottom surface of the body at an angle with respect to a line parallel to the outer surface of the body having a value within a range having a lower limit of approximately 25° and an upper limit of approximately 35°.

7. The grommet of claim 6, wherein the angle of the tapered bottom portion of the annular bead is equal to approximately 30°.

8. A grommet of claim 1, comprising a body bottom portion extending from the tapered bottom portion of the annular bead to the bottom surface of the body.

9. The grommet of claim 8, wherein the body bottom portion is cylindrical and has a bottom portion outer diameter that is equal to the bottom outer diameter of the tapered bottom portion of the annular bead.

10. The grommet of claim 1, wherein the opening of the header plate has an opening inner diameter, and wherein the bottom outer diameter of the tapered bottom portion of the annular bead is less than the opening inner diameter.

11. The grommet of claim 10, wherein the body outer diameter is greater than the opening inner diameter.

12. The grommet of claim 1, wherein the body comprises an inner surface defining a cylindrical bore extending from the top surface of the body to the bottom surface of the body, wherein the inner surface further defines an annular groove of the cylindrical bore extending into the annular shoulder.

13. A grommet for insertion into an opening of a header plate of a radiator, the grommet comprising:
a generally cylindrical body having a top surface, a bottom surface, a cylindrical outer surface having a body outer diameter, and an inner surface defining a cylindrical bore extending from the top surface of the body to the bottom surface of the body;
an annular shoulder proximate the top surface of the body and extending outwardly beyond the outer surface of the body and having a shoulder outer diameter that is greater than the body outer diameter;
an annular bead proximate the bottom surface of the body and extending outwardly beyond the outer surface of the body and having a bead outer diameter that is greater than the body outer diameter, the annular bead comprising:
a curved top portion, and
a tapered bottom portion having a decreasing outer diameter as the tapered bottom portion extends from the curved top portion downwardly toward the bottom surface of the body, with the tapered bottom portion terminating with a bottom outer diameter that is less than the body outer diameter; and
a cylindrical body bottom portion extending from the tapered bottom portion of the annular bead to the bottom surface of the body, wherein the body bottom portion has a bottom portion outer diameter equal to the bottom outer diameter of the tapered bottom portion.

14. The grommet of claim 13, wherein the curved top portion comprises an outer surface having a circular arc.

15. The grommet of claim 13, wherein the curved top portion of the annular bead extends outwardly from the outer surface of the body at an initial angle with respect to a line parallel to the outer surface of the body having a value within a range having a lower limit of approximately 40° and an upper limit of approximately 50°.

16. The grommet of claim 15, wherein the initial angle of the curved top portion is equal to approximately 45°.

17. The grommet of claim 13, wherein the tapered bottom portion of the annular bead approaches the bottom surface of the body at an angle with respect to a line parallel to the outer surface of the body having a value within a range having a lower limit of approximately 25° and an upper limit of approximately 35°.

18. The grommet of claim 17, wherein the angle of the tapered bottom portion of the annular bead is equal to approximately 30°.

19. The grommet of claim 13, wherein the opening of the header plate has an opening inner diameter, and wherein the bottom outer diameter of the tapered bottom portion of the annular bead is less than the opening inner diameter.

20. The grommet of claim 19, wherein the body outer diameter is greater than the opening inner diameter.
